(19) United States
(12) Patent Application Publication
(10) Pub. No.: US 2006/0117028 A1
(43) Pub. Date: Jun. 1, 2006

(54) Method of analysing activity in a network of interconnected computers

(76) Inventors: John Harrison, Ponteland (GB); John Mawson, North Gosforth (GB)

Correspondence Address: Zilka-Kotab, PC, P.O. BOX 721120, SAN JOSE, CA, 95172-1120, US

(21) Appl. No.: 10/534,373

(22) PCT Filed: Nov. 21, 2003
(86) PCT No.: PCT/GB03/05081

§ 371 Date: Dec. 22, 2005

(30) Foreign Application Priority Data
Nov. 23, 2002 (GB) 0227396.9

(51) Int. Cl. G06F 17/30

(52) U.S. Cl. 707/100

(57) ABSTRACT

A method of acquiring data relating to website activity in a network of interconnected computers is described. The method includes defining, at a first computer (1), a first computer code defining a set of data parameters, the values of which are to be acquired from a second computer (3). The method also includes supplying to the second computer (3), in response to a request for web page data sent to the first computer (1) from the second computer (3), web page data together with the first computer code.

The present invention relates to a method of analysing activity in a network of interconnected computers, and relates particularly, but not exclusively, to a method of analysing Internet website user activity.

In recent years, use of the Internet, also known as the World Wide Web, has grown enormously. Modern Internet websites can be extremely sophisticated and offer a wide range of services and information for the user, as well as offering goods and services for sale.

As a result of this, there has been an increasing demand from website proprietors Lo be able to analyse how the websites are being used, so that they can constantly audit and improve their websites. For example, a proprietor may wish to know for how long and by how many users its website has been accessed, or may wish to acquire more sophisticated information such as which link to the website has generated the most business or income in a particular period.

One known method of website activity analysis is known as log file analysis. Websites are displayed on user's computers by means of software known as browser software, usually as a combination or text and graphics, although the website itself consists of computer codes stored on a server computer (known as the web server) located remotely from the user's computer. When a user sends a request for a website to the Internet, the web server sends the website, via the Internet, to the user's browser.

Most servers are capable of generating log files which are stored on the web server and accumulate simple data such as the number of times the pages of the website have been requested. In order for the website proprietor to obtain information about traffic involving the website, the log file must be downloaded to the proprietor's computer and analysed by software running on this computer.

Log file analysis suffers from a number of disadvantages. Firstly, log files are often quite large and therefore take a considerable amount of time to download and require large amounts of disk space. As a result of this, by the time a log file is downloaded and analysed, it is likely that further traffic will have occurred on the website, and the log file will therefore represent out-of-date information.

Furthermore, log file analysis does not take caching into account. A cache is an intermediate point in the Internet, between the user and the web server, at which some of the website code is stored, for example text or graphics files. This reduces traffic on the Internet, and speeds up user access to websites, since some of the code for a particular website may already be stored at an intermediate point and may therefore not need to be sent from the web server. As a result of this, a website cannot record data relating to the access of cached information, and will therefore provide an inaccurate representation of website user activity.

Another prior art method of website activity analysis is known as tagging. Tagging comprises adding a portion of computer code, usually in the JavaScript programming language, to the main website code such that when the browser software of the user's computer processes the website code, it also activates the tag. The tag, when activated, then acquires information about use of the website to which it is attached, and uploads this information to a separate server, called an analysis server, at which analysis of traffic on the website can be carried out. The analysis server is pre-programmed to accept certain data types acquired by the tag, and stores the data accordingly. The website proprietor can then access the website traffic data stored on the analysis server. In this way, the method of tagging is more up to date than log file analysis, and is also independent of caching, as the actual data acquisition takes place at the user's computer.

However, tagging suffers from the drawback that the tag can only record data that the analysis server is pre-programmed to accept, which makes this method of data acquisition inherently inflexible. For example, if a new type of data not included in the types the tag is pre-programmed to look for is required, both the analysis server and the web server must be reprogrammed. As a result, access to the analysis server software is required, as a result of which the security of the analysis server may be compromised.

Preferred embodiments of the present invention seek to overcome the above disadvantages of the prior art.

According to an aspect of the present invention, there is provided a method of acquiring data relating to website activity in a network of interconnected computers, the method comprising:
defining, at a first computer, a first computer code defining a set of data parameters, the values of which are to be acquired from a second computer; and
supplying to said second computer, in response to a request for web page data sent to said first computer from said second computer, web page data together with said first computer code;
wherein said first computer code is adapted to acquire from said second computer the values of said set of data parameters and provide said values, together with data identifying said parameters, to a third computer.

This provides the advantage that the person setting up or altering web page data can decide the parameters of which data is to be collected, and the data identifying said parameters enables the data to be analysed at the third computer without the necessity of reprogramming both the first and third computers.

Said data identifying said parameters may represent the type and/or format and/or description of said data values.

The method may further comprise the step of supplying a second computer code to said second computer, wherein said second computer code is adapted to encrypt said data values and/or said data identifying said parameters.

By supplying a second computer code adapted to be executed at the second computer to encrypt data sent from said second computer, this provides the advantage of making data transmitted by the second computer more difficult to intercept, since it can be encrypted before it is sent to a location remote from the second computer.

According to another aspect of the present invention, there is provided a method of monitoring website activity in a network of interconnected computers, the method comprising:
receiving at a first computer, in response to a request for web page data sent from a second computer to a third computer, a set of data values, representing values of a set of parameters relating to said second computer, from said second computer together with data identifying said parameters; and
analysing said data values using said data identifying said parameters.

The data identifying said parameters may represent the type and/or format and/or description of said data values.

The method may further comprise the step of providing a second computer code to said second computer, wherein said second computer code is adapted to encrypt data supplied by said second computer.

According to a further aspect of the present invention, there is provided a computer program product comprising:
a first computer code to be supplied by a first computer and adapted to define a set of data parameters, the values of which are to be acquired from a second computer; and
a second computer code defining data identifying said parameters;
wherein said first and second computer codes are adapted to be supplied to said second computer in response to a request from said second computer for web page data from said first computer and to provide said data values together with said data identifying said parameters to a third computer.

The computer program product may further comprise a third computer code adapted to encrypt data send from said second computer.

A preferred embodiment of the invention will now be described, by way of example only and not in any limitative sense, with reference to the accompanying drawing in which:

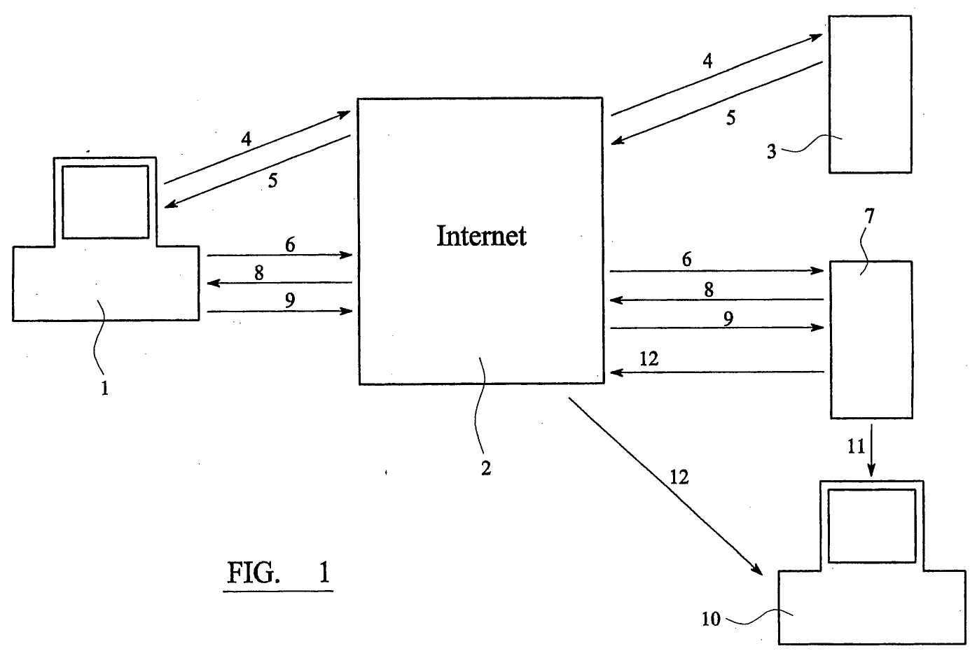

FIG. 1 is a schematic representation illustrating a network of interconnected computers executing a process embodying the present invention.

Referring to FIG. 1, a user operating a personal computer 1 logs on to the Internet 2 which physically comprises a plurality of computers 3 known as servers (only one of which is shown in FIG. 1) connected by optical fibres and/or telephone lines and, using browser software running on computer 2, requests a page from a website from the Internet by entering the appropriate URL (Universal Resource Locator) of the website. This request 4 is passed to the Internet, which then routes the request 4 to a server 3 (known as a web server) which stores the computer code of the requested website.

The web server 3 then sends the requested website data 5 to the user computer 1 via the internet 2. The code of the requested website 5 contains what is known as a JavaScript tag which, as will be familiar to persons skilled in the art, is a portion of code written in the JavaScript programming language added to the main code of the website, the function of which will be described in greater detail below.

The browser software running on the user computer 1 interprets the website code and displays the website to the user. At the same time, the browser software activates the tag which, when activated, compiles a set of data containing information about the user's activity on the website. The type of data being compiled is preprogrammed into the tag at the web server 3 and, for example, may comprise information relating to which hyperlinks the user accesses, up to more complex information such as how the user arrived at the website, and so on. The information obtained by the tag may represent a variety of different things, and may also be in several different formats. For this reason, the tag also compiles a set of data containing information about the type and format of the data collected as an aid to interpreting the compiled data.

The tag, when activated, also sends a request 6 for a program module via the Internet 2 to an analysis server 7, i.e. a computer at which the data compiled by the tag is to be analysed, or to the web server 3. The analysis server 7, which may be the computer of the website proprietor or may be the computer of a third party carrying out data analysis on behalf of the website proprietor, or the web server 3, then sends the program module 8 to the user computer 1, via the Internet 2. This program module 8 contains computer code which is able to encrypt all of the data obtained by the tag. The encrypted tag data, and encrypted data type and format information 9, is then sent automatically to the analysis server 7 via the Internet 2.

At the analysis server 7, the type and format data is de-encrypted and used to operate software stored on the analysis server 7 that stores and interprets each type of activity data into a separate data field. In this way, any type of data format from any application can be obtained by the tag, and the analysis server will be instructed how to deal with it automatically.

A second user 10, who is most likely the website proprietor, can now download the analysed data 11 from the analysis server 7. This can be done in the form of directly sent data 11, or indirect data 12 via the Internet 2, in which case the data 12 is likely to be encrypted.

It will be appreciated by persons skilled in the art that the above embodiment has been described by way of example only and not in any limitative sense, and various alterations and modifications are possible without departure from the scope of the invention as defined by the appended claims.

1-10. (canceled)

11. A method of acquiring data relating to website activity in a network of interconnected computers, the method comprising:
defining, at a first computer, a first computer code defining a set of data parameters, the values of which are to be acquired from a second computer; and
supplying to said second computer, in response to a request for web page data sent to said first computer from said second computer, web page data together with said first computer code;
wherein said first computer code is adapted to acquire from said second computer the values of said set of data parameters and provide said values, together with data identifying said parameters, to a third computer.

12. A method according to claim 11, wherein said data identifying said parameters represents the type and/or format and/or description of said data values.

13. A method according to claim 11, further comprising the step of supplying a second computer code to said second computer, wherein said second computer code is adapted to encrypt said data values and/or said data identifying said parameters.

14. A method of monitoring website activity in a network of interconnected computers, the method comprising:
receiving at a first computer, in response to a request for web page data sent from a second computer to a third computer, a set of data values, representing values of a set of parameters relating to said second computer, from said second computer together with data identifying said parameters; and
analysing said data values using said data identifying said parameters.

15. A method according to claim 14, wherein the data identifying said parameters represents the type and/or format and/or description of said data values.

16. A method according to claim 14, further comprising the step of providing a second computer code to said second computer, wherein said second computer code is adapted to encrypt data supplied by said second computer.

17. A computer program product comprising:
a first computer code to be supplied by a first computer and adapted to define a set of data parameters, the values of which are to be acquired from a second computer; and
a second computer code defining data identifying said parameters;
wherein said first and second computer codes are adapted to be supplied to said second computer in response to a request from said second computer for web page data from said first computer and to provide said data values together with said data identifying said parameters to a third computer.

18. A computer program product according to claim 17, further comprising a third computer code adapted to encrypt data sent from said second computer.
